(19) United States
(12) Patent Application Publication
(10) Pub. No.: US 2014/0082045 A1
(43) Pub. Date: Mar. 20, 2014

(54) Responsive Modification of Electronic Content

(71) Applicants: John Robert Shapiro, San Francisco, CA (US); Joe Michael Andolina, San Francisco, CA (US); Jakub Mateusz Burkot, San Francisco, CA (US)

(72) Inventors: John Robert Shapiro, San Francisco, CA (US); Joe Michael Andolina, San Francisco, CA (US); Jakub Mateusz Burkot, San Francisco, CA (US)

(73) Assignee: Adobe Systems Incorporated, San Jose, CA (US)

(21) Appl. No.: 13/618,457

(22) Filed: Sep. 14, 2012

(51) Int. Cl. G06F 15/16

(52) U.S. Cl. 709/203

(57) ABSTRACT

Systems and methods for responsive modification of electronic content are provided. In one embodiment, a moderator application executed by a processor accesses electronic content and provides the electronic content to a first client. The first client is restricted to accessing a first portion of a displayed area or frame sequence of the electronic content. The moderator application restricts the first client to performing only a first subset of modifications to the electronic content. Responsive to the first client performing one of the first subset of modifications, the moderator application provides the electronic content to a second client. The second client is restricted to accessing a second portion of the displayed area or the displayed frame sequence of the electronic content. The moderator application restricts the second client performing only a second subset of modifications to the electronic content.

### TECHNICAL FIELD

This disclosure relates generally to computer-implemented methods and systems and more particularly relates to responsive modification of electronic content.

### BACKGROUND

Consumers of electronic content may wish to be creative by, for example, adding comments or supplying additional electronic content. Various existing solutions may allow users to modify electronic content items or associate additional electronic content with an electronic content item, such as by adding a caption to a picture. Such solutions do not adequately control how users access and modify the electronic content.

### SUMMARY

One embodiment involves a processor accessing electronic content. The embodiment further involves providing the electronic content to a first client. The first client is restricted to accessing a first portion of a displayed area or a displayed frame sequence of the electronic content. The embodiment further involves restricting a first modification of the first portion of the electronic content by the first client such that the first client can only perform a first subset of modifications to the electronic content. The embodiment further involves, responsive to the first client performing one of the first subset of modifications, providing the electronic content to a second client. The second client is restricted to accessing a second portion of the displayed area or the displayed frame sequence of the electronic content. The embodiment further involves restricting a second modification to the portion of the electronic content by the second client such that the second client can only perform a second subset of modifications to the electronic content.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings, where:

FIG. 1 is a block diagram depicting example computing systems for implementing certain embodiments;

FIG. 2 is a flow chart illustrating an example method for responsively modifying shared electronic content;

FIG. 3 is a modeling diagram illustrating example modifications to electronic content via an image-flip activity;

FIG. 4 is a flow chart illustrating an example method for modifying electronic content via an image-flip activity;

FIG. 5 is a modeling diagram illustrating example modifications to electronic content via a draw-stack activity;

FIG. 6 is a modeling diagram illustrating example modifications to electronic content via a draw-stack activity;

FIG. 7 is a flow chart illustrating an example method for modifying electronic content via a draw-stack activity;

FIG. 8 is a modeling diagram illustrating example modifications to electronic content via an infinite-zoom activity; and

FIG. 9 is a flow chart illustrating an example method for modifying electronic content via an infinite-zoom activity.

### DETAILED DESCRIPTION

Computer-implemented systems and methods are disclosed for responsively modifying shared electronic content. For example, a social media application may control the type and sequence of modifications to electronic content by different users of the social media application. The social media application may provide a photo-flip game allowing multiple participants to generate a chain of related items of electronic content, where each participant adds a creative response to the previously added item. Each item of electronic content can be a link in the chain. For example, a first participant can provide a picture of a banana peel. The social media application may provide the picture of the banana to a second participant, who is restricted to adding a caption. The second participant can add a caption to the picture, such as “Who ate my banana?” The social media application may provide only the caption “Who ate my banana?” to a third participant, who is restricted to adding a picture. The third participant can add a picture related to the caption “Who ate my banana?”, such as a photo of an ape. The social media application may provide only the photo of the ape to a fourth participant, who is restricted to adding a new caption. The fourth participant can add a new caption to the picture of the ape, such as “Madhouse!” The social media application may provide only the caption to a fifth participant, who is restricted to adding a picture. The fifth participant can add a picture to the caption, such as a photo of the U.S. Capitol Building. The entire chain of electronic content items, including all photos and captions, can be displayed to all participants after each participant has provided a link in the chain.

In accordance with one embodiment, a moderator application or other application, such as a game application, can be provided for responsively modifying shared electronic content. The moderator application or other application can access electronic content, such as (but not limited to) a still image, video content, textual content, audio content, etc. The moderator application or other application can provide the electronic content to a first client. The moderator application or other application can restrict the first client to accessing a first portion of the electronic content, such as a first displayed area or a first displayed frame sequence of the electronic content. The moderator application or other application can also restrict the first client to performing a first subset of available modifications to the electronic content. In response to the first client performing one of the first subset of modifications, the moderator application or other application can provide the electronic content to a second client. The moderator application or other application can restrict the second client to accessing a second portion of the electronic content, such as a second displayed area or displayed frame sequence. The moderator application or other application can also restrict the second client to performing a second subset of available modifications to the electronic content.

As used herein, the term “electronic content” is used to refer to any type of media that can be rendered for display or use at a computing system or other electronic device. Electronic content can include text or multimedia files, such as images, video, audio, or any combination thereof. Electronic content can also include application software that is designed to perform one or more specific tasks at a computing system.

As used herein, the term “client” is used to refer to an application and/or a device executing an application accessing a moderator application or other application via a client account. A client account can include an identifier for an entity, such as an individual. A client account can also include one or more authentication credentials, such as a password, personal identification number, a security question and an associated answer, etc. In some embodiments, a single client corresponding to a single client account can be associated with a single computing device. In other embodiments, multiple clients corresponding to multiple respective accounts can be associated with a single computing device. In other embodiments, a single client corresponding to a single client account can be associated with multiple computing devices.

In an example embodiment, a client can post a challenge. An example of a challenge is a text description associated with electronic content such as, for example, an image or video. One or more permissions can control access to the challenge. Permissions associated with the challenge can allow the challenge to be displayed to one or more of friends of the client posting the challenge, a general public, or a subset of clients within a given physical proximity to a geographical location associated with the challenge. A respondent client can view a challenge and post a response to the challenge. A response can include, for example, an image or other electronic content. Posting the response can include associating the response with the challenge such that both the challenge and the response are simultaneously displayed by the moderator application.

In additional or alternative embodiments, each of multiple clients can view a challenge and post a respective response to the challenge. One or more of the multiple clients can view each response. One or more of the multiple clients can vote on each of the responses such that a response receiving a plurality of votes is selected as a winning response. The winning challenge can be associated with the response such that both the challenge and the response are simultaneously displayed by the moderator application. In some embodiments, voting on each of the responses can include providing a score for one or more criteria associated with the response. Non-limiting examples of the one or more criteria can include whether the challenge is “funny,” “cool,” etc. In other embodiments, voting on each of the responses can include indicating whether a client “likes” or otherwise selects a given response. In additional or alternative embodiments, the moderator application can assign points or credits to a client posting a winning response. In additional or alternative embodiments, each of multiple clients can view a challenge and post a respective response to the challenge. The client posting the challenge can select a winning response. In additional or alternative embodiments, one or more clients can comment on responses to a challenge. Non-limiting examples of responses can include posting text, video, images, etc.

In additional or alternative embodiments, the moderator application can provide an image-flip activity. The moderator application can select or otherwise provide an item of electronic content, such as (but not limited to) an image or a video. In some embodiments, the moderator application can select the item of electronic content in response to input received from a client. The client can view a list including one or more items of available electronic content. The client can select an item of available electronic content from the list. In other embodiments, the moderator application can select the item of electronic content automatically. The moderator application can provide the first item of electronic content to a first client. The first client can select or otherwise provide a second item of electronic content, such as (but not limited to) a caption or other text, to be associated with a first item of electronic content (i.e., the image or a video). The moderator application can provide the first and second items of electronic content to a second client. In some embodiments, the first client can select the second client. The first client can identify the second client to the moderator application via any suitable identification data. Non-limiting examples of suitable identification data can include an email address of the second client, selection of the second client from a list of clients identified as “friends” or otherwise associated with the first client, and the like. In other embodiments, the moderator application can automatically select the second client. Automatically selecting the second client can include the moderator application selecting the second client without the first client identifying the second client. Non-limiting examples of automatically selecting the second client can include selecting the second client at random or selecting the second client based on an algorithm executed by the moderator application.

The moderator application can lock an item of electronic content. Locking electronic content can include preventing clients other than a selected client from accessing the chain of electronic content. In some embodiments, the moderator application can lock the item of electronic content for a given amount of time. The moderator application can release the item of electronic content in response to a client failing to complete a turn before the given amount of time elapses. Releasing the item of electronic content in response to the given amount of time elapsing can prevent stagnation in a collaborative activity. Releasing the item of electronic content can include allowing a different client to access the electronic content. In other embodiments, the moderator application can lock the item of electronic content until a respective client completes a turn.

Completing a turn can include selecting an additional item of electronic content to be associated with the item of electronic content. For each turn, the moderator application can allow a respective client to view the most recently added item of electronic content and prevent the respective client from viewing previously added items of electronic content. Allowing turn-based access to electronic content can prevent multiple clients from providing conflicting modifications to electronic content, such as (but not limited to), contemporaneously providing multiple captions for the same image or video.

For example, an item of electronic content provided to a first client can be an image. The first client can select or otherwise provide a second item of electronic content, such as a caption or other textual content, to be associated with the image. The first and second items of electronic content can be provided to a second client via the moderator application. The moderator application can allow the second client to view the second item of electronic content (i.e., the caption or other textual content) and prevent the second client from viewing the first item of electronic content (i.e., the image associated with the caption). The second client can select or otherwise provide a third item of electronic content, such as (but not limited to) an additional image, to be associated with the second item of electronic content. Non-limiting examples of selecting or otherwise providing the image can include selecting an image from an internet resource, selecting an image from a local memory device, using a camera to capture a new image and upload the new image, and the like. The items of electronic content can be provided to a third client via the moderator application. The moderator application can allow the third client to view the third item of electronic content (i.e., the image provided by the second client) and prevent the third client from viewing any of the other items of electronic content (i.e., the initial image and the caption provided by the first client). The third client can select or otherwise provide a third item of electronic content, such as (but not limited to) an additional caption or other textual content, to be associated with the third item of electronic content. A non-limiting example of providing an additional caption or other textual content can include selecting the text of the caption, a font or other display characteristic of the text, a size for the text, and/or a position of the text with respect to the image provided by the second client. The moderator application can repeat the process described above for any number of clients. The moderator application can provide all of the electronic content items added by respective clients for display to one or more of the client and/or for public display. In some embodiments, the moderator application can provide all of the electronic content items for display in response to each of a given number of clients completing a respective turn. In additional or alternative embodiments, the moderator application can provide all of the electronic content items for display in response to a given amount of time elapsing. The moderator application can provide the electronic content for display via any suitable mechanism such as (but not limited to) a notification via e-mail or a system-level notification.

In additional or alternative embodiments, the electronic content of the image-flip activity can be associated with permissions. The permissions can allow the electronic content to be viewed and modified by any client, allow the electronic content to be viewed and modified by a specific subset of clients, or allow the electronic content to be viewed by all clients and modified by a specific subset of clients.

In some embodiments, the moderator application can limit the items of content available to a client. In one example, the moderator application may allow a client to select or otherwise provide only images or video content to be associated with other images or video content. In another example, the moderator application may allow a client to select or otherwise provide only textual content to be associated with images or video content.

In additional or alternative embodiments, the moderator application can provide a draw-stack activity. Each client participating in a draw-stack activity can create or otherwise provide a horizontal or vertical drawing. Each client can receive a frame. The frame can include a portion of the electronic content to be rendered for display at a computing device associated with a client. The frame can be delineated by one or more boundaries. A portion of electronic content at the edge of one frame can be identical to a portion of electronic content at the edge of an adjacent frame. In some embodiments, the moderator application can provide a pre-defined number of frames. A first client can modify the electronic content within the boundaries of a first frame associated with the first client. The moderator application can provide the electronic content to a second client. The moderator application can allow the second client to view all of the electronic content within the boundaries of the first frame or a portion of the electronic content within the boundaries of the first frame that is within a given distance from the electronic content within the boundaries of a second frame associated with the second client. The second client can modify the electronic content within the boundaries of the second frame. The moderator application can provide the electronic content to any number of additional clients, where each client is associated with a respective frame. For example, a first client may modify electronic content within a first frame having dimensions of eight inches by eight inches. A second client may be provided a second frame that includes a portion of the content within a strip along an edge of the first frame having dimensions of eight inches by one inch. The second client can add or otherwise modify electronic content within the second frame.

In additional or alternative embodiments, the moderator application can provide a collaborative mural activity. The moderator application can provide a mural that includes multiple tiles of image content. Each tile can include a portion of the electronic content to be rendered for display at a computing device associated with a client. Each tile can be delineated by one or more boundaries. Each of multiple clients can see all claimed and unclaimed tiles. A claimed tile can be a tile associated with a respective client. An unclaimed tile can be a tile that is not associated with any client. Each client can claim a respective tile. The client can modify the image content within the boundaries of the respective tile. In some embodiments, the moderator application can provide a time limit after which the mural as modified by the multiple clients is automatically submitted. In other embodiments, the moderator application can provide a time limit after which the tiles are released and drawings by the multiple clients are discarded. In other embodiments, the moderator application can execute an algorithm to selectively make tiles available based on the tiles that have been completed previously. Such an algorithm can be configured to prevent holes in the image content of the mural or prevent the image content of the mural from predominating in one physical direction. For example, the algorithm may prevent clients from selecting tiles in a given direction based on a threshold number of tiles in proximity to an edge of the mural being modified.

In additional or alternative embodiments, the moderator application can provide an infinite-zoom activity. A first client can select or otherwise provide an image. The moderator application can provide the image to a second client. The second client can center the image at a given position and scale the image by a given order of magnitude. In some embodiments, the second client can control the position and order of magnitude. Scaling the image can include zooming in or zooming out. In other embodiments, the moderator application can select the position and order of magnitude automatically. The second client can modify a portion of the image. The moderator application can provide the image to any number of clients. The moderator application can provide the image to each client and display the progression of the stream from the lowest level, zooming out, and seeing the complete image. In additional or alternative embodiments, a client may be allowed to see or be prevented from viewing previous modifications to the image.

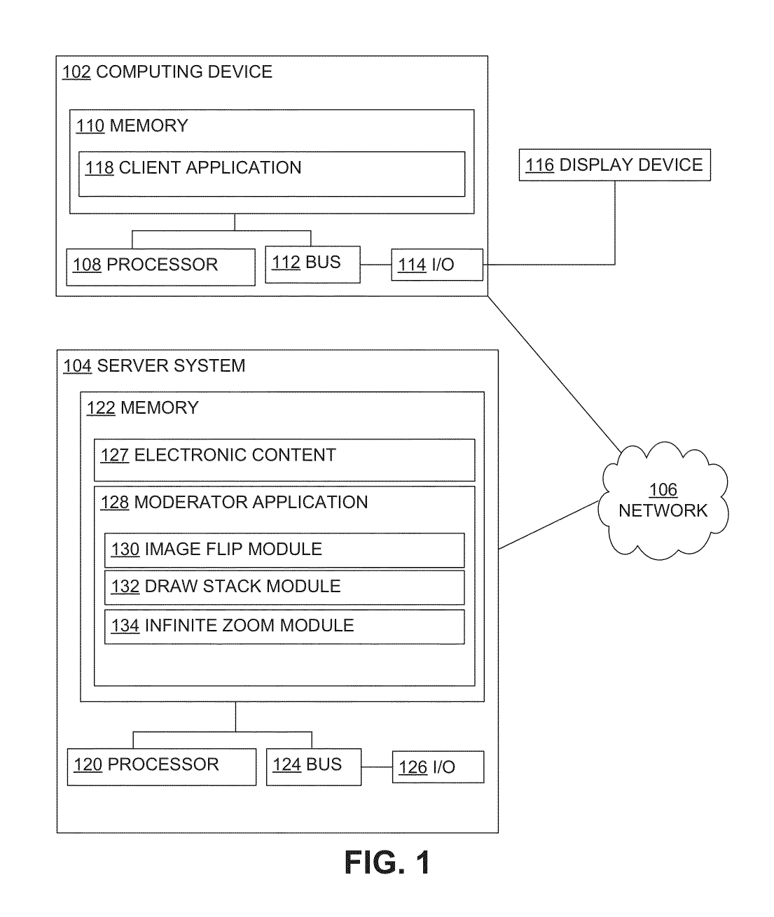

Referring now to the drawings, FIG. 1 is a block diagram depicting exemplary computing systems for implementing certain embodiments. The exemplary computing systems include a computing device 102 and a server system 104 in communication via a network 106.

The computing device 102 comprises a computer-readable medium such as a processor 108 communicatively coupled to a memory 110 that executes computer-executable program instructions and/or accesses information stored in the memory 110. The processor 108 may comprise a microprocessor, an application-specific integrated circuit (“ASIC”), a state machine, or other processor. The processor 108 can include any of a number of computer processing devices, including one. Such a processor can include or may be in communication with a computer-readable medium. The computer-readable medium stores instructions that when executed by the processor, cause the processor to perform the steps described herein.

A computer-readable medium may comprise, but is not limited to, electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

The computing device 102 may also comprise a number of external or internal devices such as a mouse, a CD-ROM, DVD, a keyboard, a display, audio speakers, one or more microphones, or any other input or output devices. For example, the computing device 102 is shown with an input/output (“I/O”) interface 114 and a display device 116. A bus 112 can be respectively included in the computing device 102. The bus 112 can communicatively couple one or more components of the computing device 102.

FIG. 1 also illustrates the client application 118 comprised in the memory 110 of the computing device 102. The client application 118 can include one or more software modules. The client application 118 can configure the processor 108 to modify or otherwise access electronic content 127 provided by the server system 104 via the network 106. The client application 118 can configure the processor 108 to render some or all of the electronic content 127 for display at the display device 116. For example, a client application 118 can be an internet browser application. A web session for accessing or otherwise modifying the electronic content 127 can be established by the browser application via the network 106 between a computing device 102 and the server system 104.

The computing device 102 can include any suitable client device for communicating via a network 106 and executing the client application 118. Non-limiting examples of a computing device include a desktop computer, a tablet computer, a smart phone, or any other computing device suitable for rendering electronic content.

The server system 104 comprises a computer-readable medium such as a processor 120 communicatively coupled to a memory 122 that executes computer-executable program instructions and/or accesses information stored in the memory 122. The processor 120 may comprise a microprocessor, an ASIC, a state machine, or other processor. The processor 120 can include any of a number of computer processing devices, including one. Such a processor can include or may be in communication with a computer-readable medium storing instructions that, when executed by the processor 120, cause the processor to perform the steps described herein.

The server system 104 can provide access to the electronic content 127. The electronic content 127 may be resident in any suitable computer-readable medium and execute on any suitable processor. In one embodiment, the electronic content 127 can reside in the memory 122 at the server system 104. In another embodiment, the electronic content 127 can be accessed by the server system 104 from a remote location via the network 106 and provided to the computing device 102 and the server system 104.

A moderator application 128 stored in the memory 122 can configure the processor 120 to retrieve electronic content 127 provided by the server system 104 via the network 106. The moderator application 128 can configure the processor 120 to store some or all of the electronic content 127 in the memory 122 or any other suitable computer-readable medium.

The server system 104 may also comprise a number of external or internal devices such as input or output devices. For example, the server system 104 is shown with an input/output (“I/O”) interface 126. A bus 124 can also be included in the server system 104. The bus 124 can communicatively couple one or more components of the server system 104.

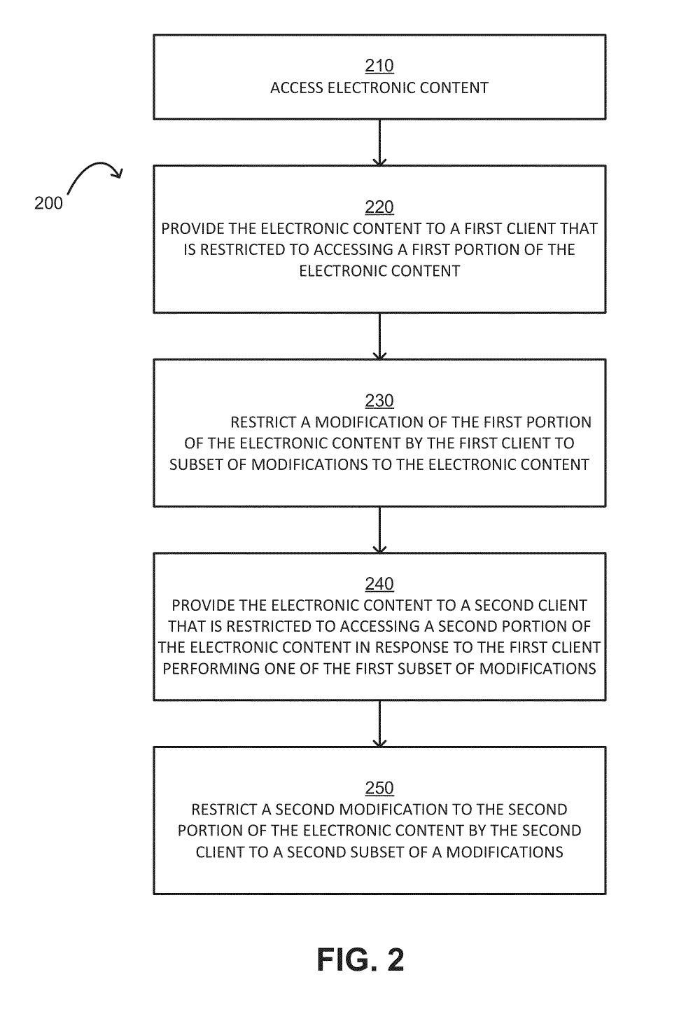

FIG. 1 also illustrates the moderator application 128 comprised in the memory 122 of the server system 104. The moderator application 128 can configure the server system 104 to modify the electronic content 127 in response to input provided by the client application 118. The moderator application 128 can also configure the server system 104 to allow multiple computing devices 102 to modify some or all of the electronic content 127, as described in detail below with respect to FIGS. 2-10.

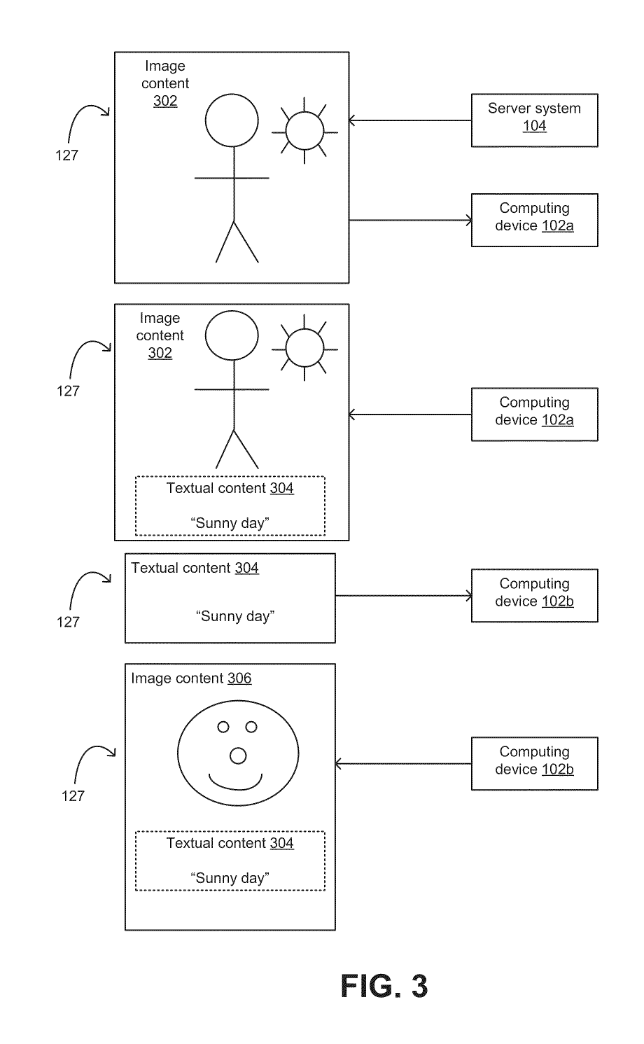

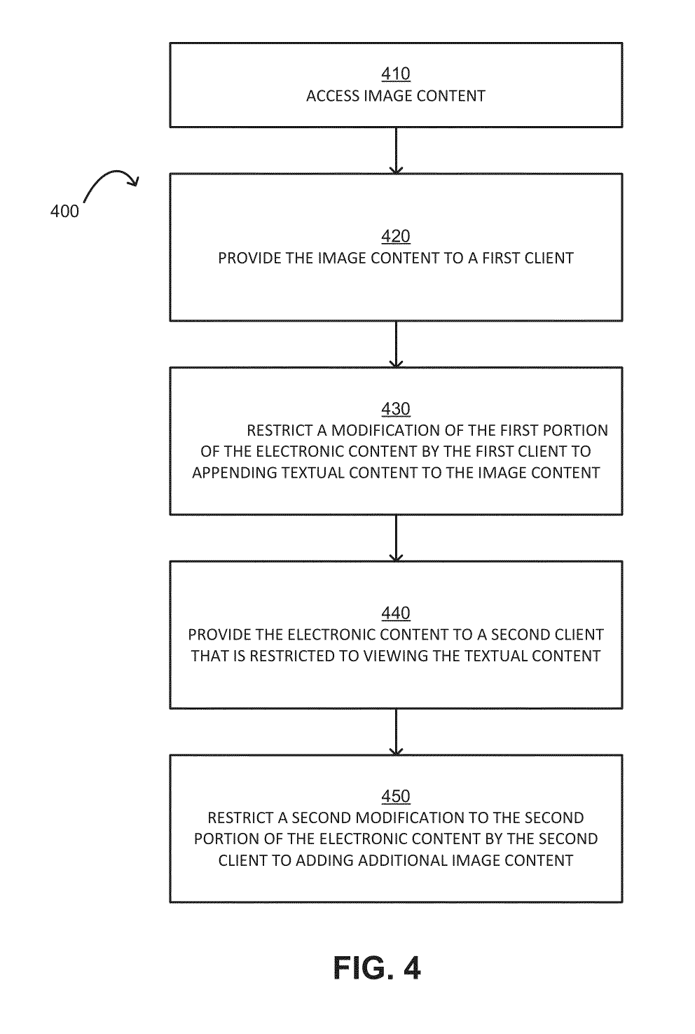

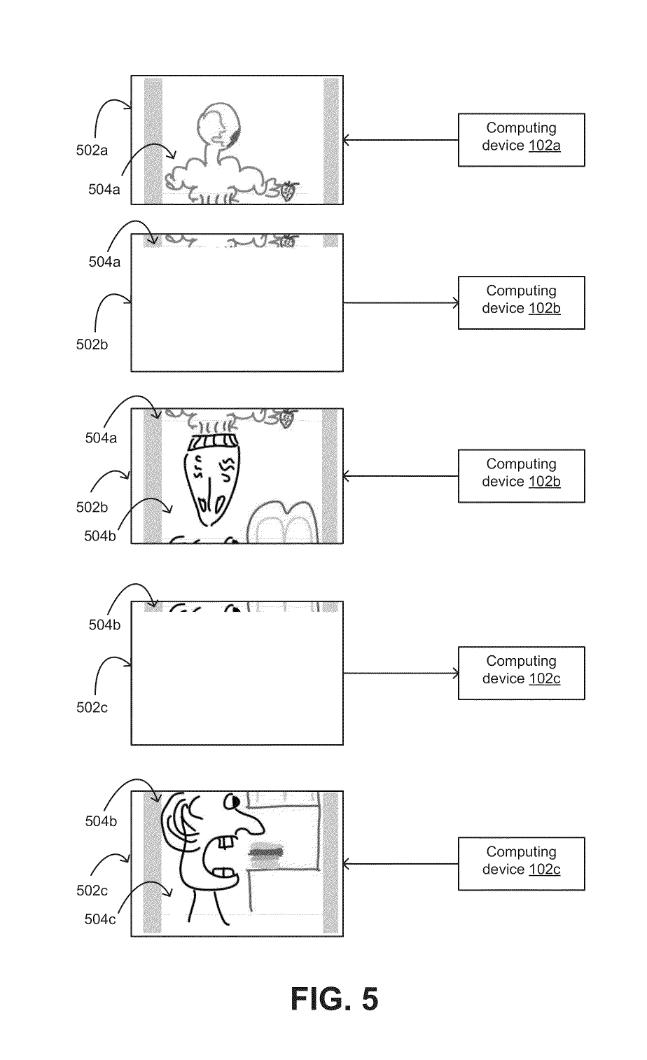

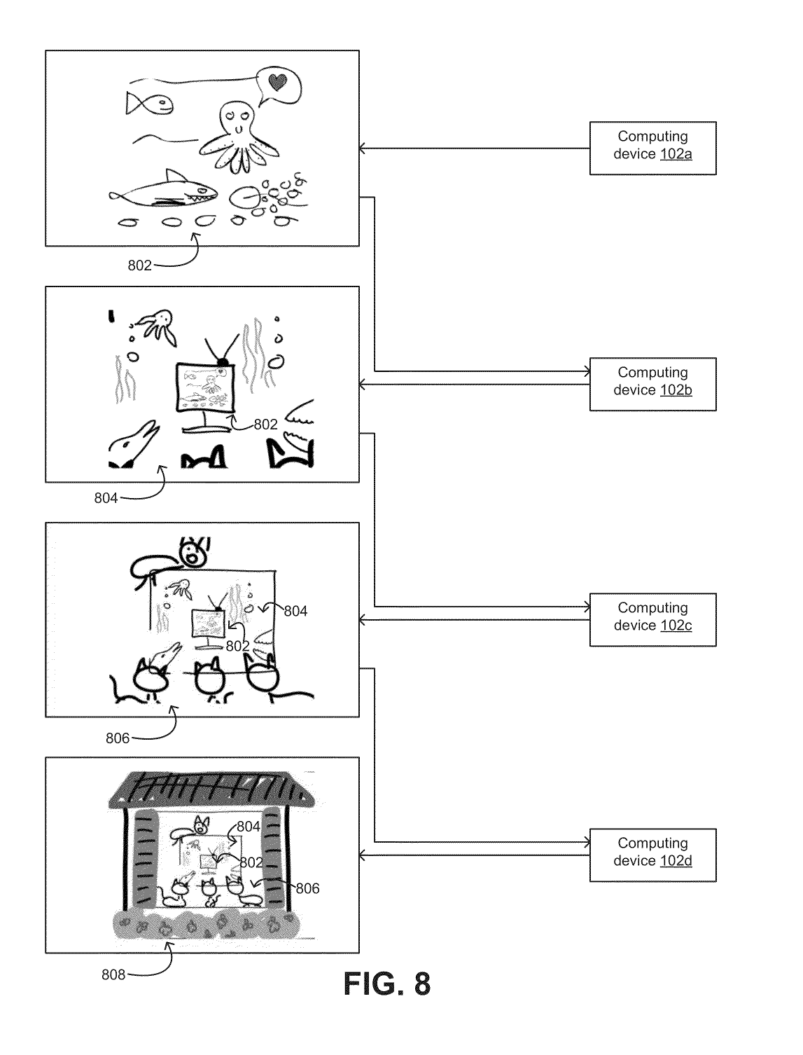

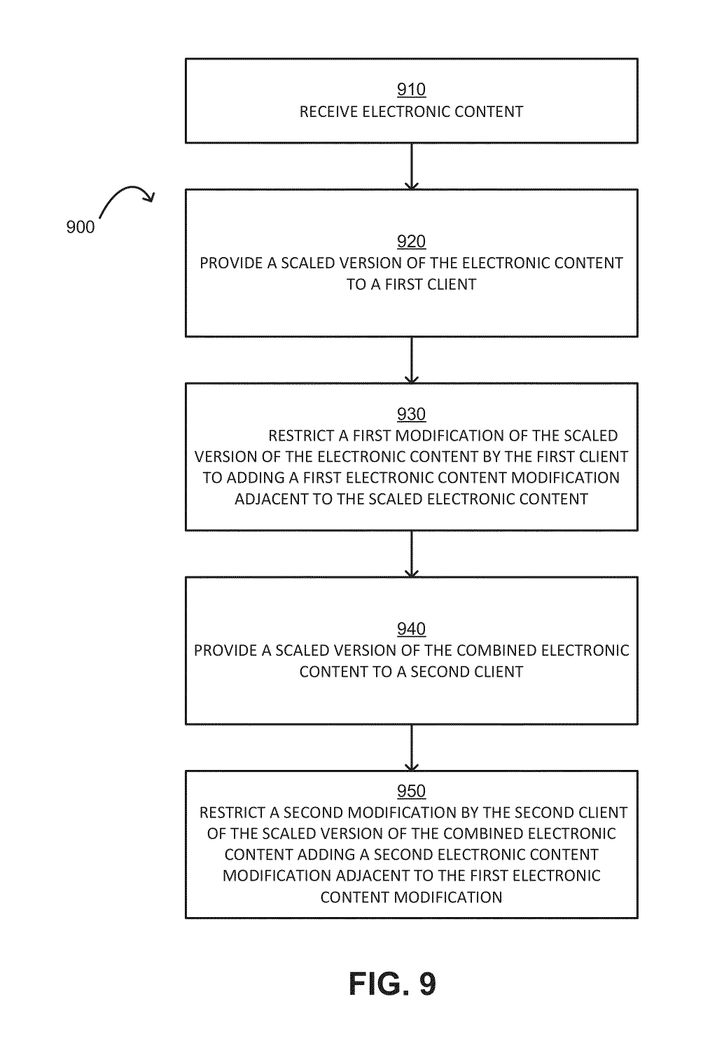

The moderator application 128 can include one or more modules, such as (but not limited to) an image flip module 130, a draw stack module 132, and an infinite zoom module 134. The image flip module 130 can configure the server system 104 to provide an image-flip activity, as described below with respect to FIGS. 3-4. The draw stack module 132 can configure the server system 104 to provide a draw-stack activity, as described below with respect to FIGS. 5-7. The infinite zoom module 134 can configure the server system 104 to provide an infinite-zoom activity, as described below with respect to FIGS. 8-9.

Although FIG. 1 depicts the image flip module 130, the draw stack module 132, and the infinite zoom module 134 as separate modules, the features provided by one or more of the modules can be provided by a single software module of the moderator application. Although FIG. 1 depicts the image flip module 130, the draw stack module 132, and the infinite zoom module 134 as modules of the moderator application 128, one or more of the image flip module 130, the draw stack module 132, and the infinite zoom module 134 can be separate applications accessed or otherwise used by the moderator application 128.

The server system 104 can include any suitable computing system for hosting the moderator application 128. In one embodiment, the server system 104 may be a single computing system. In another embodiment, the server system 104 may be a virtual server implemented using a number of computing systems connected in a grid or cloud computing topology.

The moderator application 128 can be executed at the server system 104 by the processor 120 to provide responsive modification of the electronic content 127 by multiple clients. FIG. 2 is a flow chart illustrating an example method 200 for responsively modifying shared electronic content. For illustrative purposes, the method 200 is described with reference to the system implementations depicted in FIG. 1. Other implementations, however, are possible.

The method 200 involves accessing electronic content 127, as shown in block 210. The processor 120 of the server system 104 can execute the moderator application 128 to access the electronic content 127.

The method 200 further involves providing the electronic content 127 to a first client that is restricted to accessing a first portion of the electronic content 127, as shown in block 220. Examples of the first portion of the electronic content 127 include a first displayed area or a first displayed frame sequence of the electronic content. A first client can be, for example, a computer device 102 executing a client application 118 by the processor 108. The processor 120 of the server system 104 can execute the moderator application 128 to provide the electronic content 127 to the client application 118 of the first client via the network 106.

The moderator application 128 can lock the first portion of the electronic content 127. Locking an item of the electronic content 127 can include preventing clients other than a specific client from accessing the chain of electronic content.

In some embodiments, the moderator application 128 can lock the item of electronic content for a given amount of time. The moderator application 128 can release the item of electronic content in response to a client failing to complete a turn before the given amount of time elapses. Releasing the item of electronic content in response to the given amount of time elapsing can prevent stagnation in a collaborative activity moderated by the moderator application 128. Releasing the item of electronic content can include allowing one or more additional clients to access the item of electronic content and/or providing the item of electronic content to another client.

In other embodiments, the moderator application 128 can lock the item of electronic content until a respective client completes a turn. Completing a turn can include selecting an additional item of electronic content to be associated with the item of electronic content. For each turn, the moderator application 128 can allow a respective client to view the most recently added item of electronic content and prevent the respective client from viewing previously added items of electronic content.

The method 200 further involves restricting a first modification of the first portion of the electronic content 127 by the first client such that the first client can only perform a first subset of modifications to the electronic content 127, as shown in block 230. The processor 120 can execute the moderator application 128 to restrict the access to the electronic content 127 by the client application 118 of the first client. The moderator application 128 may provide a set of allowable modifications to the electronic content 127. For example, a set of allowable modifications can include adding image content to the electronic content 127 and adding text content to the electronic content 127. The moderator application 128 may restrict a client application of a first client to performing only one of the allowable modifications (i.e., only adding image content or only adding text content).

The method 200 further involves providing the electronic content 127 to a second client that is restricted to accessing a second portion of the electronic content 127 responsive to the first client performing one of the first subset of modifications, as shown in block 240. A second client can be, for example, an additional computer device 102 executing a client application 118 by a processor 108 of the additional computing device 102. Non-limiting examples of the second portion of the electronic content 127 include a second displayed area or a second displayed frame sequence. In some embodiments, the first client and the second client can be the same type of computing device executing a client application. In other embodiments, the first client and the second client can be a different type of computing device executing a client application. The processor 120 of the server system 104 can execute the moderator application 128 to provide the electronic content 127 to the client application 118 of the second client via the network 106.

In some embodiments, the moderator application 128 can apply one or more permissions to the electronic content 127. The permissions can control access to the electronic content 127.

In some embodiments, permissions associated with the electronic content 127 can allow the electronic content 127 to be displayed to one or more of friends of the first client. A first client can be “friends” with a second client where each of the first client and the second client are associated with a respective account of a subscription-based service and where the account of the first client is associated with the account of the second client. The subscription-based service can provide access to the moderator application 128 by multiple clients. For example, a first client can access a moderator application 128 provided by, for example, a social media service using a first set of authentication credentials and a second client can access the moderator application 128 using a second set of authentication credentials.

In other embodiments, permissions associated with the electronic content 127 can allow the electronic content 127 to be displayed publically. The moderator application 128 can publically display the electronic content 127 by, for example, providing access to the electronic content 127 or a portion of the electronic content 127 to any client accessing the moderator application.

In other embodiments, permissions associated with the electronic content 127 can allow the electronic content 127 to be displayed to clients within a given physical proximity to a geographical location associated with the electronic content 127. In one embodiment, a geographical location associated with the electronic content 127 can include a geographical location of a computing device 102 modifying the electronic content 127. A geographical location of a computing device 102 modifying the electronic content 127 can be stored in the memory 122 as metadata describing the electronic content 127. In another embodiment, a geographical location associated with the electronic content 127 can include a geographical location referenced by the electronic content 127.

In additional or alternative embodiments, the server application 119 may embed permissions in a portion of electronic content 127 provided to a given client. The permissions can control which modifications a client may make to the portion of electronic content 127. For example, a portion of electronic content, such as textual content, may be embedded with permissions allowing a client to only associate a photograph or other image content with the textual content. A different portion of electronic content, such as image content, may be embedded with permissions allowing a client to only append textual content to the image content.

In additional or alternative embodiments, the server application 119 may restrict modifications to a given portion of electronic content 127 by modifying the interface used to display the given portion of electronic content 127 by a respective client application. For example, a portion of electronic content, such as textual content, may be presented via an interface for uploading a photograph or other image content to be associated with the textual content. A different portion of electronic content, such as image content, may be presented via an interface for appending textual content to the image content, such as a text box or typewriter function.

In some embodiments, the first client can select the second client. The first client can identify the second client to the moderator application via any suitable identification data. Non-limiting examples of suitable identification data can include an email address of the second client, selection of the second client from a list of clients identified as “friends” or otherwise associated with the first client, and the like. In other embodiments, the moderator application 128 can automatically select the second client. Automatically selecting the second client can include the moderator application 128 selecting the second client without the first client identifying the second client. Non-limiting examples of automatically selecting the second client can include selecting the second client at random or selecting the second client based on an algorithm executed by the moderator application 128.

The method 200 further involves restricting a second modification of the second portion of the electronic content 127 by the second client such that the second client can only perform a second subset of modifications to the electronic content 127, as shown in block 250. For example, a set of allowable modifications can include adding image content to the electronic content 127 and adding text content to the electronic content 127. The moderator application 128 may restrict a client application of a second client to performing only one of the allowable modifications (i.e., only adding image content or only adding text content).

In additional or alternative embodiments, the subset of modifications to which a second client is restricted may be dependent on a subset of modifications to which a first client is restricted. For example, a set of allowable modifications can include adding image content to the electronic content 127 and adding text content to the electronic content 127. Each client may alternatively be restricted to performing only one of the allowable modifications. A first client may be restricted to adding image content to the electronic content 127. A second client receiving the electronic content from the first client may be restricted to adding text content to the electronic content 127. A third client receiving the electronic content from the second client may be restricted to adding image content to the electronic content 127.

In additional or alternative embodiments, each of multiple clients can view the second portion of the electronic content 127. Each client can post or otherwise provide a respective modification to the electronic content 127. Each modification can be a response to the electronic content 127 as modified or otherwise provided by the first client. One or more of the multiple clients can view each modification from each other client. One or more of the multiple clients can vote on each of the modifications such that a modification receiving a plurality of votes is selected as a winning modification. The electronic content 127 can be modified to include the winning modification. In some embodiments, voting on each of the modifications can include providing a score for one or more criteria associated with the modification. Non-limiting examples of the one or more criteria can include whether the challenge is “funny,” “cool,” etc. In other embodiments, voting on each of the modifications can include indicating whether a voting client “likes” or otherwise selects a given modification. In additional or alternative embodiments, the first client can select a winning modification to the electronic content 127.

In additional or alternative embodiments, the moderator application 128 can assign points or other credits to a client posting or otherwise providing a winning modification to the electronic content 127.

In additional or alternative embodiments, one or more clients can comment on a modification to the electronic content 127. Non-limiting examples of responses can include posting text, video, images, etc.

In some embodiments, the moderator application 128 can operate in a “push” mode. A push mode can include the moderator application 128 automatically selecting each of the clients for a collaborative activity moderated by the moderator application 128. In other embodiments, the moderator application 128 can operate in a “pull” mode. A pull mode can include the moderator application 128 including multiple clients in a collaborative activity moderated by the moderator application 128 in response to the moderator application 128 receiving a request for access from each respective client. A non-limiting example of a pull mode can include multiple clients accessing a web site providing access to the moderator application 128.

In additional or alternative embodiments, the moderator application 128 or another application can provide an image-flip activity. FIG. 3 is a modeling diagram illustrating example modifications to electronic content 127 via an image-flip activity. The moderator application 128 can execute the image flip module 130 to provide the image-flip activity.

The server system 104 can execute the moderator application 128 to select or otherwise provide an item of electronic content 127, such as (but not limited to) an image or a video. The moderator application 128 can sequentially provide the electronic content 127 to any number of clients. The moderator application 128 can restrict each client to viewing only the portion of the electronic content 127 modified by the previous client. For example, as depicted in FIG. 3, the moderator application 128 may provide image content 302, such as an image of a person standing in the sun, to a first client, such as a computing device 102a. Non-limiting examples of the image content 302 can include a single image, video content that includes a series of sequential images, etc. The computing device 102a can select or otherwise provide textual content 304, such as a caption “Sunny day,” to be appended or otherwise associated with the image content 302. The textual content 304 can be associated with the image content 302. The moderator application 128 can provide the textual content 304 to or otherwise associated with a second client, such as a computing device 102b. The computing device 102b can select or otherwise provide additional image content 306, such as an image of a smiling face, to be appended to or otherwise associated with the textual content 304.

Although FIG. 3 depicts each client alternately providing either image content or textual content, any combination of electronic content can be used. In some embodiments, each client can provide additional image content. In other embodiments, each client can alternately provide either image content or audio content.

FIG. 4 is a flow chart illustrating an example method 400 for modifying electronic content 127 via an image-flip activity. For illustrative purposes, the method 400 is described with reference to the system implementations depicted in FIGS. 1 and 3. Other implementations, however, are possible.

The method 400 involves accessing electronic content 127 that includes the image content 302, as shown in block 410. The processor 120 of the server system 104 can execute the moderator application 128 to access the image content 302. In some embodiments, the moderator application 128 can automatically access and select image content 302 that is stored in the memory 122 of the server system 104. In other embodiments, a client application 118 executed at a computing device 102 can provide the image content 302 to the moderator application 128. In other embodiments, the moderator application 128 can select the image content 302 in response to input received from a client. The client can view a list including one or more items of available electronic content. The client can select an item of available electronic content, such as the image content 302, from the list.

The method 400 further involves providing the image content 302 to a first client, as shown in block 420. The first client can be, for example, the computer device 102a. The processor 120 of the server system 104 can execute the moderator application 128 to provide the image content 302 to the client application 118 of the first client via the network 106.

The method 400 further involves restricting a first modification to the electronic content 127 by the first client such that the first client can only append textual content 304 to the image content 302, as shown in block 430. For example, the moderator application 128 can restrict the computing device 102a to adding only textual content 304 to the image content 302.

The method 400 further involves providing the electronic content 127 to a second client that is restricted to viewing the textual content 304 (or some portion thereof) added by the first client, as shown in block 440. The second client can be, for example, the computer device 102b.

The method 400 further involves restricting a second modification of the electronic content 127 by the second client such that the second client can only append additional image content 306 to the textual content 304, as shown in block 450. The moderator application 128 can restrict the computing device 102b to adding only additional image content 306 to the textual content 304.

In additional or alternative embodiments, the moderator application 128 can associate permissions with the electronic content 127 of an image-flip activity. The permissions can allow the electronic content 127 to be viewed and modified by any client, allow the electronic content 127 to be viewed and modified by a specific subset of clients, or allow the electronic content 127 to be viewed by all clients and modified by a specific subset of clients.

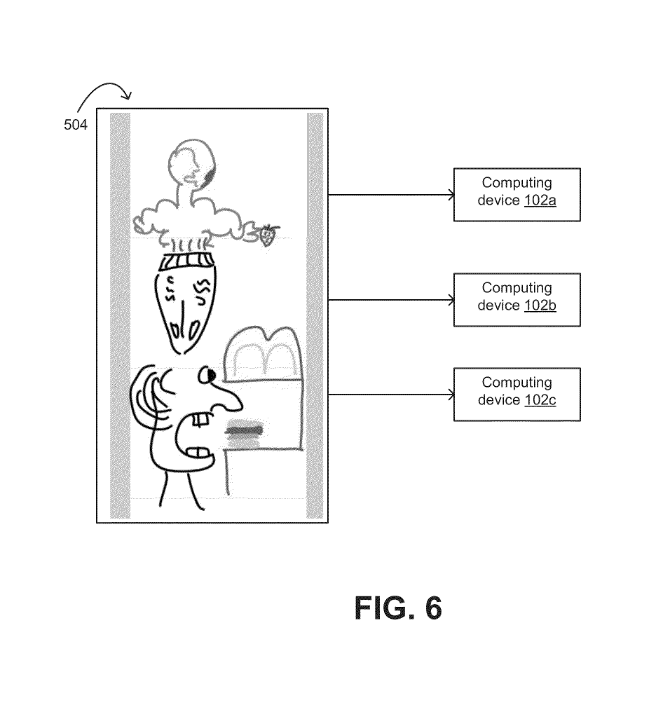

In additional or alternative embodiments, the moderator application 128 can provide a draw-stack activity. FIGS. 5-6 are modeling diagrams illustrating example modifications to electronic content 127 via a draw-stack activity. The moderator application 128 can execute the draw stack module 132 to provide the draw-stack activity.

Each of multiple clients, such as computing devices 102a-c, can be a frame to be modified by a respective client. A frame can include a portion of the electronic content 127 delineated by predetermined boundaries. For example, a server system 104 can execute the moderator application 128 to provide a frame 502a to a first client, such as a computing device 102a. The computing device 102a can add electronic content, such as the drawing 504a, to the frame 502a. The server system 104 can provide a frame 502b to a second client, such as the computing device 102b. An edge of the frame 502b can include a portion of the drawing 504a. The computing device 102b can add electronic content, such as the drawing 504b, to the frame 502b. The server system 104 can provide a frame 502c to a third client, such as the computing device 102c. An edge of the frame 502c can include a portion of the drawing 504b. The computing device 102c can add electronic content, such as the drawing 504c, to the frame 502c. The server system 104 can provide electronic content 504, including the drawings 504a-c, to all of the computing devices 102a-c, as depicted in FIG. 6.

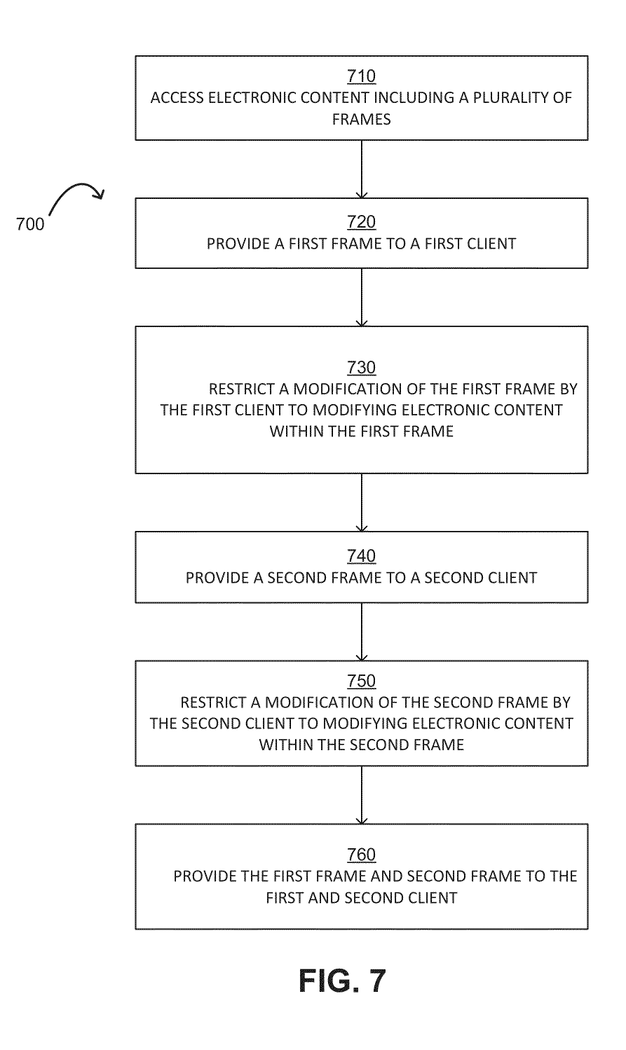

FIG. 7 is a flow chart illustrating an example method 700 for modifying electronic content 127 via a draw-stack activity. For illustrative purposes, the method 700 is described with reference to the system implementation depicted in FIGS. 1, 5, and 6. Other implementations, however, are possible.

The method 700 involves accessing electronic content 127 that includes the frames 502a-c, as shown in block 710. The processor 120 of the server system 104 can execute the moderator application 128 to access the image content 302. In some embodiments, the moderator application 128 can provide a pre-defined number of frames to clients.

The method 700 further involves providing a first frame 502a to a first client, as shown in block 720. The first client can be, for example, the computer device 102a.

The method 700 further involves restricting a first modification to the electronic content 127 by the first client such that the first client can modify content within the frame 502a, as shown in block 730. The processor 120 can execute the moderator application 128 to restrict the computing device 102a to modifying content within the frame 502a.

The method 700 further involves providing a second frame 502b including a portion of the drawing 504a of the first frame 502a, as shown in block 740. The second client can be, for example, the computer device 102b.

The method 700 further involves restricting a second modification of the electronic content 127 by the second client such that the second client can add content within an unused portion of the frame 502b, as shown in block 750. The processor 120 can execute the moderator application 128 to restrict the computing device 102b to adding only additional image content 306 to the textual content 304.

The method 700 further involves providing all of the electronic content 504 to the first client and the second client, as shown in block 760. For example, each of the clients corresponding to the respective computing device 102a-c can respectively receive the frames 502a-c. The moderator application 128 can provide all of the frames 502a-c having the respective drawings 504a-c to all of the computing devices 102a-c. The moderator application 128 can provide the electronic content 504 for display via any suitable mechanism such as (but not limited to) a notification via e-mail or a system-level notification. In some embodiments, the moderator application 128 can provide all of the electronic content items for display in response to each of a given number of clients completing a respective turn. In other embodiments, the moderator application 128 can provide all of the electronic content 504 for display in response to a given amount of time elapsing.

In additional or alternative embodiments, the moderator application 128 can provide an infinite-zoom activity. FIG. 8 is a modeling diagram illustrating example modifications to electronic content 127 via an infinite-zoom activity. The moderator application 128 can execute the infinite zoom module 134 to provide the infinite-zoom activity. In an infinite-zoom activity, the moderator application 128 can provide image content to multiple clients. The moderator application 128 can provide the image to each client and display the progression of the image content from the lowest level, zooming out, and seeing the complete image.

A first client, such as a computing device 102a, can select or otherwise provide electronic content 802. The moderator application 128 can provide the electronic content 802 to a second client, such as the computing device 102b. The computing device 102b can center the image at a given position and scale the image by a given order of magnitude. In some embodiments, the computing device 102b can control the position and order of magnitude. Scaling the image can include zooming in or zooming out. In other embodiments, the moderator application 128 can select the position and order of magnitude automatically. The computing device 102b can select or otherwise provide electronic content 804 to be included adjacent to one or more of the outer boundaries of the electronic content 802. The moderator application 128 can provide the electronic content 802, 804 to a third client, such as the computing device 102c. The computing device 102c can select or otherwise provide electronic content 806 to be included adjacent to one or more of the outer boundaries of the electronic content 804. The moderator application 128 can provide the electronic content 802, 804, 806 to a fourth client, such as the computing device 102d. The computing device 102d can select or otherwise provide electronic content 808 to be included adjacent to one or more of the outer boundaries of the electronic content 806. In additional or alternative embodiments, each client may be allowed to see or be prevented from viewing previous modifications to the image.

Although FIG. 8 depicts the electronic content 802, 804, 806, 808 as image content or other graphical content, other implementations are possible. For example, one or more of the electronic content 802, 804, 806, or 808 can include textual content.

FIG. 9 is a flow chart illustrating an example method 900 for modifying electronic content 127 via an infinite-zoom activity. For illustrative purposes, the method 900 is described with reference to the system implementations depicted in FIGS. 1 and 8. Other implementations, however, are possible.

The method 900 involves receiving electronic content 802, as shown in block 910. For example, the moderator application 128 can receive the electronic content 802 from a computing device 102a. The processor 120 of the server system 104 can execute the moderator application 128 to access electronic content 127 that includes the electronic content 802.

The method 900 further involves providing a scaled version of the electronic content 802 and blank space surrounding the scaled version of the electronic content 802 to a first client, as shown in block 920. The first client can be, for example, the computer device 102b. The processor 120 of the server system 104 can execute the moderator application 128 to provide the electronic content 802 received from a client application of the computing device 102a to a client application of the computing device 102b.

In some embodiments, the computing device 102b can control the center position and order of magnitude by which the electronic content 802 is scaled. In other embodiments, the moderator application 128 can automatically select the center position and order of magnitude by which the electronic content 802 is scaled.

The method 900 further involves restricting a first modification to the electronic content 127 by the first client such that the first client can only add additional electronic content 804 adjacent to the scaled version of the electronic content 802, as shown in block 930. The processor 120 can execute the moderator application 128 to restrict the computing device 102a to adding the additional electronic content 804 adjacent to the scaled version of the electronic content 802. The additional electronic content 804 can be added adjacent to one or more edges of the scaled version of the electronic content 802.

The method 900 further involves providing a scaled version of the electronic content 802, 804 and blank space surrounding the scaled version of the electronic content 802, 804 to a second client, as shown in block 940. The second client can be, for example, the computer device 102c. The processor 120 of the server system 104 can execute the moderator application 128 to provide the electronic content 802, 804 to a client application of the computing device 102c.

In some embodiments, the computing device 102c can control the center position and order of magnitude by which the electronic content 802, 804 is scaled. In other embodiments, the moderator application 128 can automatically select the center position and order of magnitude by which the electronic content 802, 804 is scaled.

The method 900 further involves restricting a second modification to the electronic content 127 by the second client such that the second client can only add additional electronic content 806 adjacent to the scaled version of the electronic content 802, 804, as shown in block 950. The processor 120 can execute the moderator application 128 to restrict the computing device 102a to adding the additional electronic content 806 adjacent to the scaled version of the electronic content 804. The additional electronic content 804 can be added adjacent to one or more edges of the scaled version of the electronic content 804.

In additional or alternative embodiments, the moderator application 128 can provide additional activities, such as a collaborative mural activity. The moderator application 128 can provide a mural that includes multiple tiles of image content. Each of multiple clients can see all claimed and unclaimed tiles. Each client can claim a respective tile. The client can modify the image content within the boundaries of the respective tile. In some embodiments, the moderator application 128 can provide a time limit after which the mural as modified by the multiple clients may be automatically submitted. In other embodiments, the moderator application 128 can provide a time limit after which the tiles are released and drawings by the multiple clients are discarded. In other embodiments, the moderator application 128 can execute an algorithm to selectively make tiles available based on the tiles that have been completed previously. Such an algorithm can be configured to prevent holes in the image content of the mural or prevent the image content of the mural from predominating in one physical direction. For example, the algorithm may prevent clients from selecting tiles in a given direction based on a threshold number of tiles in proximity to an edge of the mural being modified.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method comprising:
accessing, by a processor, electronic content;
providing, by the processor, the electronic content to a first client, wherein the first client is restricted to accessing a first portion of a displayed area or a displayed frame sequence of the electronic content;
restricting, by the processor, a first modification of the first portion of the electronic content by the first client such that the first client can only perform a first subset of a plurality of modifications to the electronic content provided by the processor;
responsive to the first client performing one of the first subset of modifications, providing, by the processor, the electronic content to a second client, wherein the second client is restricted to accessing a second portion of the displayed area or the displayed frame sequence of the electronic content; and
restricting, by the processor, a second modification to the second portion of the displayed area or the displayed frame sequence of the electronic content by the second client such that the second client can only perform a second subset of the plurality of modifications to the electronic content.

2. The method of claim 1,
wherein the first portion comprises image content;
wherein the first subset of modifications comprises appending text to the image content;
wherein the second portion of the electronic content comprises at least a portion of the text; and
wherein the second subset of modifications comprises appending additional image content to the text.

3. The method of claim 2, wherein at least one of the image content or the additional image content comprises video content.

4. The method of claim 1,
wherein accessing the electronic content comprises receiving a first content item;
wherein the first portion of the electronic content comprises a scaled version of the first content item and blank space adjacent to the scaled version of the first content item;
wherein the first subset of modifications comprises adding a second content item in the blank space;
wherein the second portion of the electronic content comprises a scaled version of the first content item combined with the second item and additional blank space adjacent to the scaled version of the first content item combined with the second item; and
wherein the first subset of modifications comprises adding a third content item in the additional blank space.

5. The method of claim 1, further comprising:
responsive to the first client performing one of the first subset of modifications, providing, by the processor, the electronic content to a third client, wherein the third client is restricted to accessing the second portion of the electronic content;
restricting, by the processor, a third modification to the second portion of the electronic content by the third client such that the third client can perform the second subset of modifications to the electronic content; and
applying, by the processor, one of the second modification or the third modification to the electronic content.

6. The method of claim 5, wherein applying one of the second modification or the third modification to the electronic content comprises:
receiving, from each of a plurality of additional clients, input selecting one of the second modification or the third modification;
determining which of the second modification or the third modification is selected by a greater number of clients; and
applying one of the second modification or the third modification to the electronic content based on which of the second modification or the third modification is selected by the greater number of clients.

7. The method of claim 1, further comprising, responsive to the second client performing one of the second subset of modifications, providing, by the processor, access to all of the electronic content as modified by the first client and the second client to each of the first client and the second client.

8. The method of claim 1, wherein restricting the first modification to the first portion comprises embedding a first set of permissions in the first portion specifying the first subset and wherein restricting the second modification to the second portion comprises embedding a second set of permissions in the second portion specifying the second subset.

9. The method of claim 1, wherein restricting the first modification to the first portion comprises providing a first interface including the first subset and wherein restricting the second modification to the second portion comprises providing a second interface including the second subset.

10. The method of claim 9, wherein the first interface is configured to upload additional electronic content and wherein the second interface is configured to modify the electronic content.

11. A non-transitory computer-readable medium embodying program code executable by a processing device, the non-transitory computer-readable medium comprising:
program code for accessing electronic content;
program code for providing the electronic content to a first client, wherein the first client is restricted to accessing a first portion of a displayed area or a displayed frame sequence of the electronic content;
program code for restricting a first modification of the first portion of the electronic content by the first client such that the first client can only perform a first subset of a plurality of modifications to the electronic content provided by the processor;
program code for, responsive to the first client performing one of the first subset of modifications, providing the electronic content to a second client, wherein the second client is restricted to accessing a second portion of the displayed area or the displayed frame sequence of the electronic content; and
program code for restricting a second modification to the second portion of the electronic content by the second client such that the second client can only perform a second subset of the plurality of modifications to the electronic content.

12. The non-transitory computer-readable medium of claim 11,
wherein the first portion of the electronic content comprises a image content;
wherein the first subset of modifications comprises appending text to the image content;
wherein the second portion of the electronic content comprises at least a portion of the text; and
wherein the second subset of modifications comprises appending additional image content to the text.

13. The non-transitory computer-readable medium of claim 11,
wherein accessing the electronic content comprises receiving a first content item;
wherein the first portion of the electronic content comprises a scaled version of the first content item and blank space adjacent to the scaled version of the first content item;
wherein the first subset of modifications comprises adding a second content item in the blank space;
wherein the second portion of the electronic content comprises a scaled version of the first content item combined with the second item and additional blank space adjacent to the scaled version of the first content item combined with the second item; and
wherein the first subset of modifications comprises adding a third content item in the additional blank space.

14. The non-transitory computer-readable medium of claim 11, further comprising:
program code for, responsive to the first client performing one of the first subset of modifications, providing the electronic content to a third client, wherein the third client is restricted to accessing the second portion of the electronic content;
program code for restricting a third modification to the second portion of the electronic content by the third client such that the third client can perform the second subset of modifications to the electronic content; and
program code for applying one of the second modification or the third modification to the electronic content.

15. The non-transitory computer-readable medium of claim 16, wherein applying one of the second modification or the third modification to the electronic content comprises:
receiving, from each of a plurality of additional clients, input selecting one of the second modification or the third modification;
determining which of the second modification or the third modification is selected by a greater number of clients; and
applying one of the second modification or the third modification to the electronic content based on which of the second modification or the third modification is selected by the greater number of clients.

16. A system comprising:
a processor configured to execute instructions stored in a non-transitory computer-readable medium;
wherein the instructions are configured to perform operations comprising:
accessing electronic content;
providing the electronic content to a first client, wherein the first client is restricted to accessing a first portion of a displayed area or a displayed frame sequence of the electronic content;
restricting a first modification of the first portion of the electronic content by the first client such that the first client can only perform a first subset of a plurality of modifications to the electronic content provided by the processor;
responsive to the first client performing one of the first subset of modifications, providing the electronic content to a second client, wherein the second client is restricted to accessing a second portion of the displayed area or the displayed frame sequence of the electronic content; and
restricting a second modification to the second portion of the electronic content by the second client such that the second client can only perform a second subset of the plurality of modifications to the electronic content.

17. The system of claim 16,
wherein the first portion of the electronic content comprises a image content;
wherein the first subset of modifications comprises appending text to the image content;
wherein the second portion of the electronic content comprises at least a portion of the text; and
wherein the second subset of modifications comprises appending additional image content to the text.

18. The system of claim 16,
wherein accessing the electronic content comprises receiving a first content item;
wherein the first portion of the electronic content comprises a scaled version of the first content item and blank space adjacent to the scaled version of the first content item;
wherein the first subset of modifications comprises adding a second content item in the blank space;
wherein the second portion of the electronic content comprises a scaled version of the first content item combined with the second item and additional blank space adjacent to the scaled version of the first content item combined with the second item; and
wherein the first subset of modifications comprises adding a third content item in the additional blank space.

19. The system of claim 16, wherein the instructions are configured to perform additional operations comprising:
responsive to the first client performing one of the first subset of modifications, providing the electronic content to a third client, wherein the third client is restricted to accessing the second portion of the electronic content;
restricting a third modification to the second portion of the electronic content by the third client such that the third client can perform the second subset of modifications to the electronic content; and
applying one of the second modification or the third modification to the electronic content.

20. The system of claim 19, wherein applying one of the second modification or the third modification to the electronic content comprises:
receiving, from each of a plurality of additional clients, input selecting one of the second modification or the third modification;
determining which of the second modification or the third modification is selected by a greater number of clients; and
applying one of the second modification or the third modification to the electronic content based on which of the second modification or the third modification is selected by the greater number of clients.
